(19) United States
(12) Patent Application Publication
(10) Pub. No.: US 2013/0248067 A1
(43) Pub. Date: Sep. 26, 2013

(54) Non-Pneumatic Flexible Tire, the Bearing Structure of which Contains Metal Strips

(71) Applicants: Antonio Delfino, Clermont-Ferrand Cedex 9 (FR); Jean Paul Meraldi, Clermont-Ferrand Cedex 9 (FR)

(72) Inventors: Antonio Delfino, Clermont-Ferrand Cedex 9 (FR); Jean Paul Meraldi, Clermont-Ferrand Cedex 9 (FR)

(73) Assignees: MICHELIN Recherche et Technique S.A., Granges-Paccot (CH); COMPAGNIE GENERALE DES ETABLISSEMENTS MICHELIN, Clermont-Ferrand (FR)

(21) Appl. No.: 13/811,626

(22) PCT Filed: Jul. 4, 2011
(86) PCT No.: PCT/EP2011/061175

§ 371 Date: May 29, 2013

(30) Foreign Application Priority Data
Jul. 20, 2010 (FR) 1055875

(51) Int. Cl. B60B 9/00

(52) U.S. Cl. CPC B60B 9/00
USPC 152/1

(57) ABSTRACT

Flexible tire having a flexible bearing structure extending circumferentially about an axis of rotation, a tread (13) on the radially outer periphery of the bearing structure, and at least one attachment zone (11), radially on the side of the axis of rotation, for the attachment of the bearing structure to a wheel center, the bearing structure comprising a plurality of supporting elements (2) extending essentially transversally, the supporting elements being juxtaposed circumferentially and distributed all around the circumference, the supporting elements (2) including a stack of metal strips (21) with interposition of a layer of sliding material (22) between each strip.

### TECHNICAL FIELD OF THE INVENTION

The present invention relates to the tires that are fitted to wheels and designed to be capable of supporting a substantial load without inflation pressure, called non-pneumatic tires. It relates more particularly to a tire having characteristics of resistance to extreme temperatures.

### PRIOR ART

Such non-pneumatic tires have already been the subject of very many documents, some that are very old such as patents FR 373 880 and FR 418 176.

Using more modern materials, patent application WO 00/37269 also proposes such a non-pneumatic tire. It describes a bearing structure comprising essentially a plurality of supporting elements placed substantially radially, being repeated with a cyclical symmetry all around the circumference of the tire. When the tire described in patent application WO 00/37269 bears a load, a certain number of supporting elements that are present in the area of contact are subjected to considerable flexing, which enables them to develop a force of absorption of a portion of the load. An interconnection structure makes the supporting elements work together, by transferring the stresses to the adjacent supporting elements. The capacity of this tire to bear a certain load originates from the bending stress of the supporting elements that are present in the contact area of the non-pneumatic elastic tire. It also originates from the bending stress of the supporting elements outside the contact area of the non-pneumatic elastic tire, through the operation of the interconnection structure.

Finally, it may be noted that, according to the teaching of the aforementioned patent application WO 00/37269, each of the supporting elements is capable of withstanding torsion, and that there is a difference in flexion between adjacent supporting elements. It is also known that, before entering the contact area, the supporting elements sustain a degree of deradialization. When the tire is running in normal service, the entry of the supporting elements in the contact area is somewhat delayed. And gradually as the supporting elements pass through the contact area, they resume a radial position and, on leaving the contact area, they sustain a substantially symmetrical deradialization of the first relative to the vertical plane passing through the axis of rotation of the tire.

With respect to the interconnection structure, while being capable of transmitting a portion of the stress of the supporting elements to the adjacent supporting elements, it is known that it is sufficiently flexible to allow relative movements of the supporting elements with respect to one another, not only in the radial direction but also in the circumferential direction. The difference in movement of the supporting elements in the radial direction corresponds to a difference in bending stress of the latter. The difference in movement in the circumferential direction corresponds to a circumferential stressing of the interconnection structure, evidenced by the deradialization.

Such a structure provided with elastomers however has operating limits. For example, in extremely low temperatures, such as those on the moon, the elastomeric materials lose their hyperelasticity characteristics and are in a vitreous phase which makes them extremely brittle. It is therefore not possible to envisage such devices being fitted to vehicles likely to travel on the moon.

Document FR 2 839 015 describes a tire comprising supporting elements connected together by an interconnection structure with interposition of elastic articulations allowing good operation of the assembly. The interconnection structure comprises an elastomeric matrix reinforced with the aid of a brace. Such an elastomeric structure does not retain its hyperelasticity properties when used in very low temperatures preventing the use of this device for fitment to a lunar vehicle.

In order to alleviate these various drawbacks, the invention proposes various technical means.

### SUMMARY OF THE INVENTION

First of all, a first object of the invention consists in providing a tire or a wheel allowing use over an enlarged temperature range, also sufficient for uses in conditions such as those that are found on the moon.

Another object of the invention consists in providing a tire or a wheel allowing a vehicle to travel in a difficult environment without risk of puncturing or pressure loss as with conventional wheels fitted with tires with inflation.

To do this, the invention proposes a flexible tire having a flexible bearing structure extending circumferentially about an axis of rotation, a tread on the radially outer periphery of the bearing structure, and at least one attachment zone, radially on the side of the axis of rotation, for the attachment of the said bearing structure to a wheel center, the bearing structure comprising a plurality of supporting elements extending essentially transversally of which a first portion is placed at least under a portion of the tread, and of which another portion is placed beyond the tread where the supporting elements are flexed when the tire is loaded, the said supporting elements being juxtaposed circumferentially and distributed all around the circumference, the supporting elements (2) consisting of a stack of metal strips (21) with interposition of a layer of sliding material (22) between each strip, in which the tread (13) comprises a plurality of circumferential bands consisting of a stack of metal strips (31) with interposition of a layer of sliding material (32) between each strip (31).

In such an architecture, the elastic articulation is removed, allowing use over a very wide temperature range, such as for example from −200° C. to +150° C. The circumferential braces are directly attached to the radial braces. The deradialization of the radial braces is ensured by the torsional flexibility of the stratified plastic. Moreover, the stratified plastic behaviour of the radial braces is ensured by the use of a material that provides a sliding action between the individual strips.

According to an advantageous embodiment, the layer of sliding material consists of PTFE. This material has excellent characteristics both of sliding and of resistance to very low temperatures, making it particularly suitable for use on a lunar wheel.

Advantageously, the layer of sliding material is secured to the adjacent metal strip on one face and free on the other adjacent strip, so as to leave it the freedom to slide on the latter.

The layer of sliding material can be applied for example in the form of a coating, applied on only one or on both faces of the strips. An independent solid layer may also be provided for application between two strips.

Also advantageously, the circumferential bands are attached directly to the supporting elements. Various methods of mechanical or chemical attachment can be used, such as welding, rivets, screws and other attachment means. The deradialization of the supporting elements provides the flexibility necessary for the assembly to operate properly. Moreover, for the lunar wheel function, with low speeds, and for fairly short distances, the direct attachment of the circumferential elements against the radial elements provides advantageous characteristics of durability. The removal of attachment with an elastomeric matrix allows use at very low temperature which is indispensible for lunar use.

According to an advantageous embodiment, the circumferential bands are surmounted, radially outermost, by at least one leather contact band. This material has excellent performance in hostile environments, even in very low temperatures. For uses on the moon, this material is therefore very advantageous.

According to one exemplary embodiment of the invention, the supporting elements are placed substantially radially.

Advantageously, the bearing structure comprises only structural elements that are oriented radially and structural elements that are oriented circumferentially.

The supporting elements are preferably continuous from one attachment zone to the other.

According to another embodiment, the width of the supporting elements is between 5 and 15 mm for a non-pneumatic elastic tire dimensioned for a nominal load of the order of 500 kg.

According to yet another embodiment, the supporting elements are axially continuous beneath the tread.

According to another variant embodiment, the tire comprises two attachment zones of the supporting elements that can be separated axially.

### DESCRIPTION OF THE FIGURES

All the implementation details are given in the following description supplemented by FIGS. 1 to 3 shown only as non-limiting examples and in which:

FIG. 1 is a view in perspective of the non-pneumatic tire according to the invention;

FIG. 2 is a cross section of the tire of FIG. 1 showing in perspective the arrangement of the supporting elements and of the circumferential strips;

FIG. 3 is a section in the plane perpendicular to the axis of the wheel.

### DETAILED DESCRIPTION OF THE INVENTION

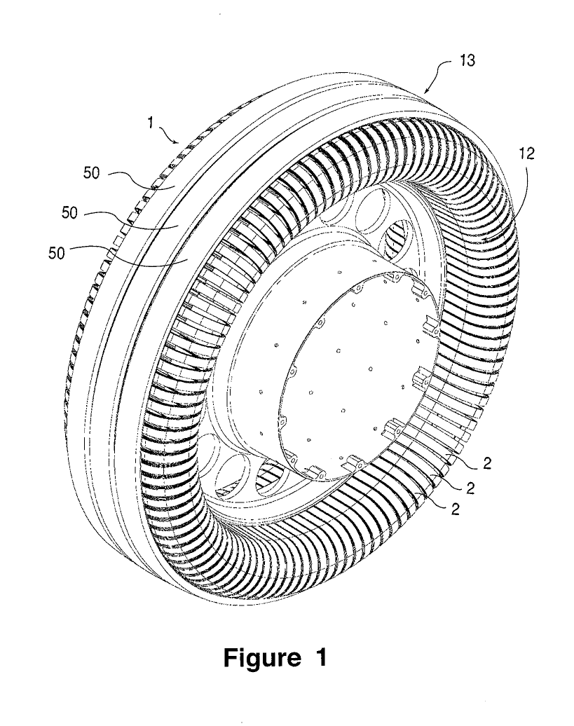

FIG. 1 illustrates an embodiment in which the profile of the tire delimits a toroidal internal cavity of ovoid section. The tire 1 comprises an attachment zone 11, two sidewalls 12 and a tread 13. The sidewalls 12 are rounded and occupy the majority of the radial height of the tire 1.

The supporting structure comprises supporting elements 2. The supporting elements 2 are circumferentially adjacent and extend in each case substantially radially from the attachment zone 11 to the tread 13 in order to pass beneath the latter before returning radially inwards, on the other side of the tire, towards the attachment zone 11. The supporting elements 2 therefore have a profile with a substantially oval shape.

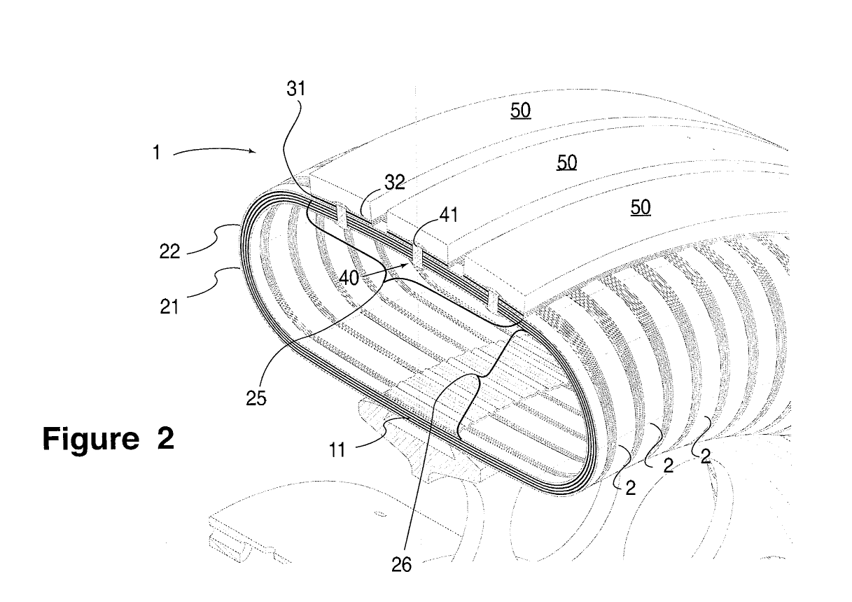

As can be seen in FIG. 2, the supporting elements 2 comprise a stack of metal strips 21 that are flexible, superposed with interposition of a layer of sliding material 22 between the strips 21. The bundle of strips thus bonded to one another forms a beam incapable of being flexed. This aspect of the make-up of the stratified plastic is however not limiting. The layer of sliding material may consist of any material, alloy or mixture having properties promoting the sliding between two adjacent strips, such as for example PTFE, known for its properties promoting sliding on the one hand, and its excellent temperature resistance on the other hand.

The thickness of the PTFE layer is advantageously between 0.3 and 1 mm. The width of the supporting elements is between 5 and 15 mm for a non-pneumatic elastic tire dimensioned for a nominal load of the order of 500 kg.

The tread 13 comprises a plurality of circumferential bands that are substantially parallel with one another and slightly spaced apart from one another. Each circumferential band consists of a stack of metal strips 31 between which a layer of sliding material 32 is provided so as to ensure sliding between the strips, promoting the radial flexing of the assembly. The layer of sliding material may consist of any material, alloy or mixture having properties promoting the sliding between two adjacent strips, such as for example PTFE, known for its properties promoting sliding on the one hand, and its excellent temperature resistance on the other hand. The thickness of the PTFE layer is advantageously between 0.3 and 1 mm.

The width of the circumferential strips is preferably between 10 and 15 mm, the thickness advantageously being between 0.3 and 0.7 mm for a non-pneumatic elastic tire dimensioned for a nominal load of the order of 500 kg.

The metal strips 21 and/or 31 may be made from different alloys. Advantageously spring steel alloys are used, such as for example grade CK75 or W. Nr 1.1248 and stainless steel W. Nr 1.4310 according to the DIN standards. Moreover, titanium is equally appropriate.

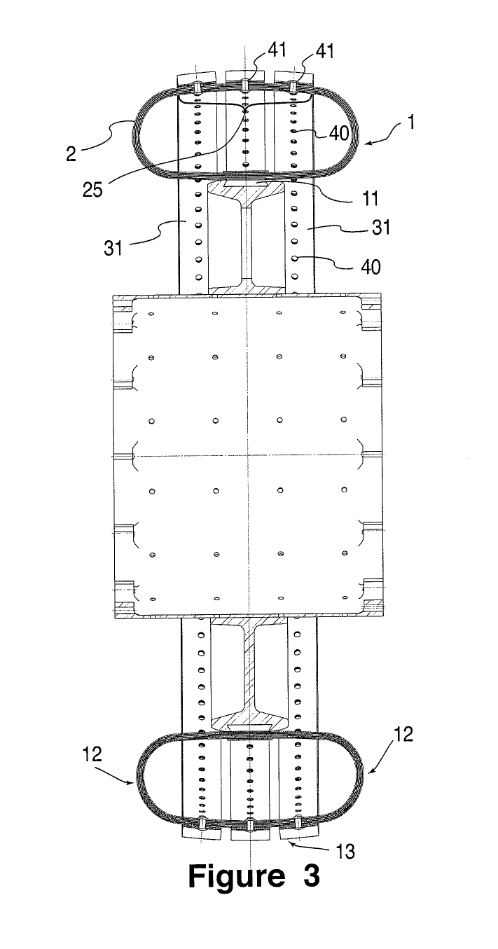

The circumferential bands are attached to the supporting elements 2 by mechanical attachment means 41 such as rivets, screws or other mechanical means or chemical means, such as an adhesive that is resistant to very low temperatures, or mechanical-chemical means such as welding, or any other means providing a durable and enduring attachment. In the example illustrated, as shown in FIGS. 2 and 3, a plurality of attaching holes 40 are provided on the supporting elements 2 and on the circumferential bands in order to allow an attachment by riveting.

The circumferential bands are surmounted, radially externally, by at least one leather contact band 50. This band performs the function of an interface between the ground and the metal strips, in order on the one hand to protect the strips and on the other hand to promote the traction and the correct behaviour of the wheel. Tests carried out with cow hide have demonstrated a very good performance, even at extremely low temperatures, such as for example in a liquid nitrogen medium. The contact band is advantageously installed by bonding between the metal strips.

The figures and their descriptions given above illustrate the invention rather than limiting it. In particular, the invention and its different variants have just been described with respect to a particular example comprising three circumferential bands.

Nevertheless, it is evident for someone skilled in the art that the invention may be extended to other embodiments in which in variants a different number of bands is provided.

The reference numbers in the claims are in no way limiting. The verbs “to include” and “to comprise” do not exclude the presence of other elements than those listed in the claims. The words “one”, “a” or “an” preceding an element do not exclude the presence of a plurality of such elements.

1. A flexible tire having a flexible bearing structure extending circumferentially about an axis of rotation, a tread on the radially outer periphery of the bearing structure, and at least one attachment zone, radially on the side of the axis of rotation, for the attachment of the bearing structure to a wheel center,
wherein the bearing structure comprises: a plurality of supporting elements extending essentially transversally of which a first portion is placed at least under a portion of the tread, and of which another portion is placed beyond the tread where the supporting elements are flexed when the tire is loaded, the supporting elements being juxtaposed circumferentially and distributed all around the circumference, the supporting elements being comprised of a stack of metal strips with interposition of a layer of sliding material between each strip; and
wherein the tread comprises a plurality of circumferential bands comprised of a stack of metal strips with interposition of a layer of sliding material between each strip.

2. The tire according to claim 1, wherein the layer of sliding material consists of PTFE.

3. The tire according to claim 1, wherein the layer of sliding material is secured to the adjacent metal strip on one face and free on the other adjacent strip, so as to leave it the freedom to slide on the latter.

4. The tire according to claim 1, wherein the circumferential bands are attached directly to the supporting elements.

5. The tire according to claim 1, wherein the circumferential bands are surmounted, radially outermost, by at least one contact band.

6. The tire according to claim 1, wherein the supporting elements are placed substantially radially.

7. The tire according to claim 1, wherein the bearing structure comprises only structural elements that are oriented radially and structural elements that are oriented circumferentially.

8. The tire according to claim 1, wherein said supporting elements are axially continuous beneath the tread.

9. The tire according to claim 1, comprising two attachment zones that can be separated axially.

10. The tire according to claim 9, wherein each supporting element is continuous from one attachment zone to the other.
